(19) United States
(12) Patent Application Publication
(10) Pub. No.: US 2021/0030044 A1
(43) Pub. Date: Feb. 4, 2021

(54) Methods for the Production and Use of Mycelial Liquid Tissue Culture

(71) Applicant: MycoTechnology, Inc., Aurora, CO (US)

(72) Inventors: James Patrick LANGAN, Aurora, CO (US); Brooks John KELLY, Aurora, CO (US); Huntington DAVIS, Aurora, CO (US); Bhupendra Kumar SONI, Aurora, CO (US); Lisa SCHMIDT, Aurora, CO (US)

(73) Assignee: MycoTechnology, Inc., Aurora, CO (US)

(21) Appl. No.: 16/927,837

(22) Filed: Jul. 13, 2020

Related U.S. Application Data
(63) Continuation-in-part of application No. 15/438,576, filed on Feb. 21, 2017, now Pat. No. 10,709,157.
Application No. 15/438,576 is a continuation-in-part of application No. 15/144,164, filed on May 2, 2016, now Pat. No. 9,572,364.
Application No. 15/144,164 is a continuation-in-part of application No. 14/836,830, filed on Aug. 26, 2015, now Pat. No. 9,572,363.
(60) Provisional application No. 62/042,071, filed on Aug. 26, 2014.
(60) Provisional application No. 62/253,567, filed on Nov. 10, 2015.
(60) Provisional application No. 62/281,546, filed on Jan. 21, 2016.

(51) Int. Cl. A23L 33/14; A23L 27/00; A23L 27/10

(52) U.S. Cl. CPC A23L 33/14; A23L 27/10; A23L 27/86

(57) ABSTRACT

A method enhancing the taste of a food product, which includes the steps of culturing a mycelial liquid tissue culture in a media, collecting a extracellular portion of the mycelial aqueous culture, e.g., the extracellular fluid of the mycelial liquid aqueous culture, and adding the collected extracellular portion fluid to a food product in an amount sufficient to enhance the food product's taste. The extracellular portion of the mycelial aqueous culture may include C. sinensis, and the culture step may be carried out for between about one and sixty days. The food products include foods, beverages, pharmaceuticals, and nutraceuticals and dairy alternative products, beverages and beverage bases, extruded and extruded/puffed products, meat imitations and extenders, baked goods and baking mixes, granola products, bar products, smoothies and juices, and soups and soup bases.

### CROSS-REFERENCE TO RELATED APPLICATIONS

This application is a continuation-in-part of U.S. patent application Ser. No. 15/438,576, filed Feb. 21, 2017, entitled “Methods for the Production and Use of Mycelial Liquid Tissue Culture,” which is a continuation-in-part of U.S. patent application Ser. No. 15/144,164, filed May 2, 2016, now U.S. Pat. No. 9,572,364, which is in turn a continuation in part of U.S. patent application Ser. No. 14/836,830, filed Aug. 26, 2015, entitled “Methods For The Production And Use Of Mycelial Liquid Tissue Culture”, now U.S. Pat. No. 9,572,363, which claims the benefit of U.S. Provisional Application No. 62/042,071, filed Aug. 26, 2014, entitled “Taste Improved Stevia Extract and Tea by Mycotechnological Methods”. U.S. patent application Ser. No. 15/144,164 also claims the benefit of U.S. Provisional Application No. 62/253,567, filed Nov. 10, 2015, entitled “Methods For The Production And Use Of Mycelial Liquid Tissue Culture”, and also claims the benefit of U.S. Provisional Application No. 62/281,546, filed Jan. 21, 2016, entitled “Methods For The Production And Use Of Mycelial Liquid Tissue Culture”. The disclosure of each of is the referenced applications are hereby incorporated by reference herein in their entireties.

### TECHNICAL FIELD

The present invention is directed to the products, and uses thereof, made with mycelial aqueous culture of the gourmet and therapeutic higher order Basidiomycetes and Ascomycetes, by the methods of the present invention.

### BACKGROUND

U.S. Pat. No. 2,693,665 discusses culturing Agaricus campestris in citrus juice, pear juice, asparagus juice, “organic material”, a carbohydrate, a nitrogen source and any combination of these materials optionally supplemented with urea and/or various ammonium salts to produce a mycelium for use as a foodstuff.

U.S. Pat. No. 2,761,246 discloses a method for the production of submerged Morchella esculenta and Helvellaceae spp. mycelium for human food. This document discusses the use of various molasses solutions as media with ammonium salt supplements. The patent discloses that added calcium carbonate or calcium sulfate acts as hyphal sphere nucleation sites, increasing biomass yield 30 fold.

U.S. Pat. No. 2,928,210 discloses a method to produce mushroom mycelium from sulfite liquor waste media supplemented with organic and inorganic salts.

U.S. Pat. No. 3,086,320 discloses a method to improve the flavor of submerged mycelium of Morchella esculenta, Helvella gigas, Coprinus comatus, and Agaricus campestris, by growing the strains in a media that “must contain, in water, a carbohydrate as a source of energy, a source of nitrogen and suitable minerals”, and includes recipes comprising milk, which is claimed to improve yield and flavor of mycelium when used properly.

U.S. Pat. No. 4,071,973 discusses culturing conditions for Basidiomycetes. Fungus is inoculated and grown in inorganic nutrient salts for nitrogen, phosphate and potassium, mixed with sucrose at 50-70 g/L and supplemented with fine powder of “crushed sugarcane, sugarcane bagasse, pine tree-tissue and wheat bran” at 0.2-15 g/L. Oxygen is controlled at 30-90% (v/v) to the media, the vessel pressurized at 0.12-0.5 MPa (17.4-72.5 psi) with oxygen supplied at 0.1-1.0 L/minute. Salts used include ammonium nitrate, sodium phosphate, magnesium sulfate heptahydrate, iron (II) sulfate heptahydrate and dipotassium hydrogen phosphate. Creative air pressure cycles are discussed and controlled with a pressure regulator. An alternative engineering scheme would use a back-pressure regulator, with a pressure regulator on the air receiver tank supplying the air.

Organizations around the world have been diligently looking for novel bitter blockers. Only a handful of patents on bitter blockers have been filed, and many are on synthetic compounds or rely on permutations of a basis molecular motif, see, e.g., EP2570035A1, U.S. Pat. Nos. 4,154,862, 5,631,292, 6,265,012, 7,939,671, US20080226788A1, US20100227039A1, US20020177576, US20110086138 and WO2008119197A1.

What is desired is a way of manufacturing a food product, such as, for example, stevia or tea that achieves a good tasting product while reducing the taste defects. Thus, a need remains in the art for products having reduced levels of undesirable taste components and/or increased levels of flavor and/or health promoting components relative to stevia or tea, and for methods of obtaining such products. The present invention is directed toward overcoming one or more of the problems discussed above.

### SUMMARY OF THE INVENTION

In one embodiment, the present invention includes a method for enhancing the taste of a food product comprising a protein isolate or concentrate, which can include the steps of culturing a mycelial aqueous culture in a media, collecting the extracellular portion fluid of the mycelial aqueous culture; and adding the collected extracellular portion fluid to a food product in an amount sufficient to enhance the food product's taste.

The fungus used to culture the mycelial tissue can include at least one of the following species: Ganoderma lucidum, Ganoderma applanatum, Cordyceps sinensis, Cordyceps militaris, Hericium erinaceus, Lentinula edodes, Agaricus blazei, Grifola frondosa, Auricularia auricula, Flammulina velutipes, Trametes versicolor, Morchella spp., Inonotus obliquus, Laricifomes officinalis, Fomes fomentarius, Fomes officinalis, Fomes fomitopisis, Tricholoma matsutake, Boletus edulis, Clitocybe nuda, Clitocybe saeva, Plearotus spp., Tremella fuciformis, Piptoporus betulinis, Polyporus umbellatus, Pholiota nameko, Volvariella volvacea, Hypsizygus marmoreus, Stropharia rugosoannulata, and Laetiporus sulfureus. In one embodiment, the fungus is Cordyceps sinensis.

In some embodiments, the food product's taste is enhanced when combined with the collected extracellular portion fluid. The taste enhancements may take any form, such as, for example, reducing bitter tastes, reducing undesirable aftertastes, and reducing astringency in the food product.

In one embodiment, the food product comprises a protein concentrate or isolate. Such protein concentrates or isolates can include protein concentrates or isolates from any source, and includes, for example, pea protein concentrate, pea protein isolate, potato protein, soy protein, rice protein, brown rice protein, whey isolate, wheat gluten, blends of soy, wheat, pea powder; also included are protein concentrates or isolates such as hemp protein, oat protein, duckweed protein, cyanobacteria, grain, chia, chickpea, potato protein, algal protein and nettle protein or combinations of these. Other sources of protein, including lower quality sources such as, corn gluten meal, may also be used. Other proteins may be used (which may or may not be in the form of isolates or concentrates) include single cell proteins such as those derived from bacterial or fungal organisms, including Neurospora, such as N. intermedia or N. crassa, Aspergillus such as A. oryzae, Fusarium such as F. venentum or F. oxysporum, or filamentous fungi such as Pleurotus (such as P. ostreatus), Lentinula (such as L. edodes), Morchella (such as M. esculenta).

In one embodiment, the collected extracellular fluid can be optionally pasteurized or sterilized. The collected extracellular fluid can also be optionally dried, either before or after the optional pasteurization or sterilization step.

In some embodiments, the culturing step can be carried out for between about one and about sixty days.

The present invention also includes compositions which comprise a combination of a food product comprising a protein concentrate or protein isolate and an extracellular portion from a mycelial aqueous culture. In some embodiments, prior to combination, the extracellular portion from the mycelial aqueous culture is a dried extracellular and the food product comprising a protein concentrate or protein isolate is a dried food product.

Various modifications and additions can be made to the embodiments discussed without departing from the scope of the invention. For example, while the embodiments described above refer to particular features, the scope of this invention also included embodiments having different combination of features and embodiments that do not include all of the above described features.

### DETAILED DESCRIPTION OF THE INVENTION

While various aspects and features of certain embodiments have been summarized above, the following detailed description illustrates a few embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described and claimed herein, and while various features are ascribed to different embodiments, it should be appreciated that the features described with respect to one embodiment may be incorporated with other embodiments as well. By the same token, however, no single feature or features of any described or claimed embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

In one embodiment, the present invention is based on the discovery that fungi cultured media (on any media as described herein) such as Cordyceps sinensis, Hericum erinaceus, or Ganoderma lucidum cultured media, can be used directly as a flavor additive, after suitable treatment such as pasteurization or sterilization prior to consumption. The cultured media can be dried, diluted, concentrated, or used neat in the forms of a concentrate, dried powder, and the like.

As a stationary mycelial mat cultures, the interface between fungal metabolite solution and remaining media steadily sinks. Interface displacement is a convenient observation for determining the health of the culture, and indicates when the culture has entered a stationary or growth phase. The forming metabolite pool often has a pleasant coloration and without being bound by theory, is believed to contain beneficial fungal material such as enzymes, carbohydrates, lipids, small molecules, and so forth that would make the material desirable as a food ingredient/supplement/additive. The inventors have found that the mycelial culture, in one embodiment, need only be filtered (with, e.g., cheesecloth, coffee filter, 0.2 micron filter) and pasteurized to isolate the extracellular fluid. Floating cultures can be used according to the present invention if blended.

In one embodiment, the present inventors have found that the a portion of a fungal liquid tissue culture fluid, the extracellular fluid, also known as supernatant fluid (containing reduced amounts of mycelium, herein referred to as the “extracellular portion” and/or “mycelium-free portion”) when added directly to a food product comprising a protein concentrate or protein isolate, has the ability to improve undesirable tastes in the food product comprising a protein concentrate or protein isolate, such as, for example, bitter tastes, astringent tastes, and/or undesirable aftertastes. Enhancing the taste of a food product comprising a protein concentrate or protein isolate includes improved sweetening by that food product comprising a protein concentrate or protein isolate. Flavor improvement also includes reduction of characteristic aftertastes associated with stevia and tea, including, without limitation, a bitter flavor, a metallic flavor, a licorice flavor, commonly as an aftertaste, which sets on after the initial sweet or tea sensation. The bitter blocker is also capable of eliminating metallic tastes in products such as potassium chloride. The bitter blocker can also be used to reduce undesirable flavor defects in breads and formulations made from various grains such as quinoa, amaranth and whole wheat. Reducing these tastes may also be referred to as mitigating taste defects.

Improved flavor of food product comprising a protein concentrate or protein isolates treated by products of the invention may be measured in a variety of ways, such as the chemical analysis which demonstrate improved sweetness, reduced bitterness and/or mitigated taste defects. Taste tests with taste panels may also be conducted to provide qualitative data with respect to improved taste(s) in the products, with the panels determining whether improved sweetness and/or decreased taste defects have been exhibited in the treated products.

Accordingly, the present invention relates to compositions comprising combinations of a extracellular portion of a mycelial aqueous culture with food products comprising a protein concentrate or protein isolate, as well as methods by which to improve a food products' taste by adding a extracellular portion of a mycelial aqueous culture to the food product wherein the combination of the food product and the extracellular portion of a mycelial aqueous culture has an enhanced taste. The compositions comprising the combinations have enhanced tastes relative to the food product comprising a protein concentrate or protein isolate alone. The inventors found that the commonly associated aftertaste of a protein concentrate or isolate was ameliorated when mixed with the whole liquid culture of Cordyceps sinensis after a 6 hour incubation.

Specifically, the inventors used filtered C. sinensis liquid tissue culture to mix with a steviol glycoside mixture for six hour incubation. After running a time course study, the inventors surprisingly discovered that the flavor enhancing effect took hold immediately upon the addition of the filtrate to the steviol glycoside mixture, indicating that the process was possibly non-enzymatic. It was conjectured that the filtered C. sinensis aqueous e.g. submerged culture (also known as the extracellular portion of a mycelial aqueous culture) had taste improving and/or bitter blocker properties. The filtered C. sinensis liquid tissue culture (filtrate) was then combined with other substances as disclosed herein, for example, in Table 9 and found to have general taste improving/bitter blocker properties for these substances. The inventors found that the filtrate may be further purified, for example, to increase solubility, and may be dried, such as spray-drying, and combined with food product comprising a protein concentrate or protein isolates to improve the food products' taste profiles, including reducing bitter tastes and/or aftertastes. The present invention thus discloses a bitter blocker that appears to be effective in a number of different types of food products.

In one embodiment, the present invention includes a method for enhancing the taste of a food product comprising a protein concentrate or protein isolate, which includes the steps of culturing a mycelial aqueous culture in a media, collecting a extracellular portion of the culture, and adding the extracellular portion to a food product to enhance the food products' taste.

A food product comprising a protein concentrate or protein isolate according to the present invention can include any food or beverage composition and also includes any substances which are taken by oral administration (by mouth), which includes protein concentrates or isolates. Any food product (e.g. food composition) comprising a protein concentrate or protein isolate which has or can have undesirable taste characteristics, such as bitter tastes, undesirable aftertastes, astringent tastes, and the like, can be treated with the bitter blocker composition of the present invention. In some embodiments, the food product can further comprise stevia rebaudioside A, steviol glycoside, stevia plant parts, whole wheat, coffee, tea, amaranth, quinoa, monk fruit, aspartame, acesulfame-k, beer, liquor, spirits, wine, sucralose, carbohydrates, potassium chloride, cacao, cacao liquor, ginseng, sugar alcohol, cranberry, grapefruit, pomegranate, and coconut.

Food products can include food compositions that comprise all cereals, grains, all species of wheat, rye, brown rice, white rice, red rice, gold rice, wild rice, rice, barley, triticale, rice, sorghum, oats, millets, quinoa, buckwheat, fonio, amaranth, teff and durum; apples and pears, apricots, cherries, almonds, peaches, strawberries, raisins, manioc, cacao, banana, Rubiaceae sp. (coffee), lemons, oranges and grapefruit; tomatoes, potatoes, peppers, eggplant, Allspice, mango powder, Angelica, Anise (Pimpinella anisum), Aniseed myrtle (Syzygium anisatum), Annatto (Bixa orellana), Apple mint (Mentha suaveolens), Artemisia vulgaris, Mugwort, Asafoetida (Ferula assafoetida), Berberis, Banana, Basil (Ocimum basilicum), Bay leaves, Bistort (Persicaria bistorta), Black cardamom, Black cumin, Blackcurrant, Black limes, Bladder wrack (Fucus vesiculosus), Blue Cohosh, Blue-leaved Mallee (Eucalyptus polybractea), Bog Labrador Tea (Rhododendron groenlandicum), Boldo (Peumus boldus), Bolivian Coriander (Porophyllum ruderale), Borage (Borago officinalis), Calamus, Calendula, Calumba (Jateorhiza calumba), Chamomile, Cannabis, Caper (Capparis spinosa), Caraway, Cardamom, Carob Pod, Cassia, Casuarina, Catnip, Cat's Claw, Catsear, Cayenne pepper, Celastrus paniculatus, Comfrey, Celery salt, Celery seed, Centaury, Chervil (Anthriscus cerefolium), Chickweed, Chicory, Chile pepper, Chili powder, Cinchona, Chives (Allium schoenoprasum), Cicely (Myrrhis odorata), Cilantro (see Coriander) (Coriandrum sativum), Cinnamon (and Cassia), Cinnamon Myrtle (Backhousia myrtifolia), Clary, Cleavers, Clover, Cloves, Coffee, Coltsfoot, Comfrey, Common Rue, Condurango, Coptis, Coriander, Costmary (Tanacetum balsamita), Couchgrass, Cow Parsley (Anthriscus sylvestris), Cowslip, Cramp Bark (Viburnum opulus), Cress, Cuban Oregano (Plectranthus amboinicus), Cudweed, Cumin, Curry leaf (Murraya koenigii), Damiana (Turnera aphrodisiaca), Dandelion (Taraxacum officinale), Demulcent, Devil's claw (Harpagophytum procumbens), Dill seed, Dill (Anethum graveolens), Dorrigo Pepper (Tasmannia stipitata), Echinacea, Echinopanax Elatum, Edelweiss, Elderberry, Elderflower, Elecampane, Eleutherococcus senticosus, Epazote (Chenopodium ambrosioides), Ephedra, Eryngium foetidum, Eucalyptus, Fennel (Foeniculum vulgare), Fenugreek, Feverfew, Figwort, Five-spice powder (Chinese), Fo-ti-tieng, Fumitory, Galangal, Garam masala, Garden cress, Garlic chives, Garlic, Ginger (Zingiber officinale), Ginkgo biloba, Ginseng, Ginseng, Siberian (Eleutherococcus senticosus), Goat's Rue (Galega officinalis), Goada masala, Golden Rod, Golden Seal, Gotu Kola, Grains of paradise (Aframomum melegueta), Grains of Selim (Xylopia aethiopica), Grape seed extract, Green tea, Ground Ivy, Guaco, Gypsywort, Hawthorn (Crataegus sanguinea), Hawthorne Tree, Hemp, Herbes de Provence, Hibiscus, Holly, Holy Thistle, Hops, Horehound, Horseradish, Horsetail (Equisetum telmateia), Hyssop (Hyssopus officinalis), Jalap, Jasmine, Jasmin pearl, Jiaogulan (Gynostemma pentaphyllum), Joe Pye weed (Gravelroot), John the Conqueror, Juniper, Kaffir Lime Leaves (Citrus hystrix, C. papedia), Kaala masala, Knotweed, Kokam, Labrador tea, Lady's Bedstraw, Lady's Mantle, Land cress, Lavender (Lavandula spp.), Ledum, Lemon Balm (Melissa officinalis), Lemon basil, Lemongrass (Cymbopogon citratus, C. flexuosus, and other species), Lemon Ironbark (Eucalyptus staigeriana), Lemon mint, Lemon Myrtle (Backhousia citriodora), Lemon Thyme, Lemon verbena (Lippia citriodora), Licorice—adaptogen, Lime Flower, Limnophila aromatica, Linseed, Liquorice, Long pepper, Lovage (Levisticum officinale), Luohanguo, Mace, Mahlab, Malabathrum, Manchurian Thorn Tree (Aralia manchurica), Mandrake, Marjoram (Origanum majorana), Marrubium vulgare, Marsh Labrador Tea, Marshmallow, Mastic, Meadowsweet, Mei Yen, Melegueta pepper (Aframomum melegueta), Mint, Milk thistle (Silybum), Bergamot (Monarda didyma), Motherwort, Mountain Skullcap, Mullein (Verbascum thapsus), Mustard, Mustard seed, Nashia inaguensis, Neem, Nepeta, Nettle, Nigella sativa, Kolanji, Black caraway, Noni, Nutmeg, Mace, Marijuana, Oenothera (Oenothera biennis), Olida (Eucalyptus olida), Oregano (Origanum vulgare, O. heracleoticum), Orris root, Osmorhiza, Olive Leaf (used in tea and as herbal supplement), Panax quinquefolius, Pandan leaf, Paprika, Parsley (Petroselinum crispurn), Passion Flower, Patchouli, Pennyroyal, Pepper (black, white, and green), Peppermint, Peppermint Gum (Eucalyptus dives), Perilla, Plantain, Pomegranate, Ponch phoran, Poppy seed, Primrose (Primula), candied flowers, dry tea mixes, Psyllium, Purslane, Quassia, Quatre epices, Ramsons, Raspberry, Raspberry (leaves), Reishi, Restharrow, Rhodiola rosea, Riberry (Syzygium luehmannii), Rocket/Arugula, Roman chamomile, Rooibos, Rosehips, Rosemary (Rosmarinus officinalis), Rowan Berries, Rue, Safflower, Saffron, Sage (Salvia officinalis), Saigon Cinnamon, St John's Wort, Salad Burnet (Sanguisorba minor or Poterium sanguisorba), Salvia, Sichuan Pepper (Sansho), Sassafras, Savory (Satureja hortensis, S. montana), Schisandra (Schisandra chinensis), Scutellaria costaricana, Senna (herb), Senna obtusifolia, Sesame seed, Sheep Sorrel, Shepherd's Purse, Sialagogue, Siberian ginseng (Eleutherococcus senticosus), Siraitia grosvenorii (luohanguo), Skullcap, Sloe Berries, Smudge Stick, Sonchus, Sorrel (Rumex spp.), Southernwood, Spearmint, Speedwell, Squill, Star anise, Stevia, Strawberry Leaves, Suma (Pfaffia paniculata), Sumac, Summer savory, Sutherlandia frutescens, Sweet grass, Sweet cicely (Myrrhis odorata), Sweet woodruff, Szechuan pepper (Xanthoxylum piperitum), Tacamahac, Tamarind, Tandoori masala, Tansy, Tarragon (Artemisia dracunculus), Tea, Teucrium polium, Thai basil, Thistle, Thyme, Toor DaIl, Tormentil, Tribulus terrestris, Tulsi (Ocimum tenuiflorum), Turmeric (Curcuma longa), Uva Ursi also known as Bearberry, Vanilla (Vanilla planifolia), Vasaka, Vervain, Vetiver, Vietnamese Coriander (Persicaria odorata), Wasabi (Wasabia japonica), Watercress, Wattleseed, Wild ginger, Wild Lettuce, Wild thyme, Winter savory, Witch Hazel, Wolfberry, Wood Avens, Wood Betony, Woodruff, Wormwood, Yarrow, Yerba Buena, Yerbe mate, Yohimbe, Za'atar, Zedoary Root, or derivations thereof in aqueous or semi-aqueous solution(s).

The step of culturing a mycelial aqueous culture may be accomplished by any methods known in the art. In one embodiment, the methods to cultivate a mycelial aqueous culture may be found in, e.g., PCT/US14/29989, filed Mar. 15, 2014, PCT/US14/29998, filed Mar. 15, 2014, U.S. 61/953,821, filed Mar. 15, 2014, U.S. 61/953,823, filed Mar. 15, 2014, U.S. 62/042,071, filed Aug. 26, 2014, all of which are incorporated by reference herein in their entireties.

In one embodiment, the mycelial aqueous culture is carried out in a bioreactor pressure vessel which is ideally constructed with a torispherical dome, cylindrical body, and spherical cap base, jacketed about the body, equipped with a magnetic drive mixer, and ports through curled-in jacket spaces to provide access for equipment comprising DO probes, pH meters, conductivity meters, thermocouples, etc., as is known in the art. These meters and probes should be data-logged. In one embodiment, the cylindrical base has a valve connected to a harvesting line which is teed off to a valve to another tee, which is teed-off to a floor sink and in-line with a CIP skid, the harvesting line tee in-line to a pasteurization skid, and finally a drying device, such as a spray dryer, fluid bed dryer, conical dryer, or other drying applications. In one embodiment, the processed mycelial aqueous culture can be packaged immediately from the dryer. A sample should be kept as control and an appropriate sample sent to a third-party quality control, Certificate of Analysis provider. Air can be provided by an air receiver tank connected to a 120/240 V air compressor. The air compressor releases air through a pressure regulator with upstream and downstream valves, immediately upstream of the upstream valve being a tee, teed-off to a valve leading to another tee, teed-off to a valve to a CIP skid, in-line with a valved steam supply, the post pressure regulator valve in-line to a valve and 0.2 μm stainless steel filter (which can be cleaned in a sonicating sink) in a stainless steel cartridge housing, which leads to an optional check valve to obligate valve on the dome of the pressure vessel, the final valve system optionally being upstream of the check valve, teed off to a y-piece which leads to two similar check valve to valve setups to 360° sprayballs. The two sprayballs are placed to account for the shadow presented by the air percolator that extends through the vessel. Pressure gauges along the set-up may be strategically placed to monitor pressure, and flow meters used to monitor air supply rates. Additional gas receiver tanks, such as oxygen tanks, can be placed in-line between the pressure regulator and the filters to calibrate partial pressures of any gas. The inventors recommend back to back filter cartridges, though this is not necessary. The gas is exhausted through a check valve with low-cracking pressure, such as a gate-valve, or a spring check valve with 2 to 3 psi cracking pressure, to a back-pressure regulator that holds the vessel at 5 to 25 psi. The back-pressure regulator can also lead to a steam trap and floor-sink. In one embodiment the set-up provides 0.5 to 5.0 ACH. Other engineering schemes known to those skilled in the art may also be used.

The reactor preferably is outfitted with a means for sterile inoculation. In one embodiment, to inoculate the reactor, a glycerol stock solution of fungi, consisting of a valved autoclavable (e.g. polypropylene) container, is taken out of the freezer, removed from its seal and attached to a cross, in-line with a valve to the chamber. The cross cross-line is valved on both ends, with the upstream valve connected to a stainless steel cartridge housing holding a stainless steel 0.2 μm filter. This line is connected to a valved tee (also valved on the upstream side) in-line to the main air supply line. Downstream of the cross is a valve to a steam strap to a floor-sink. The steam is run to sterilize the air between the glycerol stock and the valve to the chamber. Once sterilized and cooled, the vacuum between the glycerol stock and the valve to the chamber is broken. The valves on either side of the cross are closed, and the valves on the glycerol stock and pressure vessel are opened to inoculate the media. Other engineering schemes known to those skilled in the art may also be used.

The reactor should be outfitted to be filled with water. The water supply system is ideally a WFI system, with a sterilizable line between the still and the reactor. Solid media ingredients should be added to the tank pre-sterilization, ideally through a vacuum conveyor system. High temperature sterilizations are fast enough to be not detrimental to the media. Once the water is added, the tank should be mildly agitated and inoculated. In another embodiment, solid media ingredients are added to filtered or distilled water and the liquid media is sterilized at high temperatures and pumped through a sterile line into the pressure vessel. In another embodiment, the tank is filled with filtered or distilled water, the solid media ingredients are added, and the media is sterilized by steaming the either the jacket, chamber, or both, while the media is optionally being agitated.

At least one scale-up reactor should be used before approaching tanks with volumes on the order of 1×10⁵. As many as 3 to 4 are recommended. The inventors recommend going from the order of 1×10⁰ L to 1×10² L to 1×10⁴ L to 1×10⁵⁻⁶ L. Richer media can be used for the scale-up reactors and pre-glycerol stock culturing motifs.

The glycerol stock disclosed herein is prepared, in one embodiment, by a simple propagation motif of Petri plate to 0.1 L to 4 L Erlenmeyer shake flask to 50% glycerol stock. Petri plates can comprise agar in 25 to 35 g/L in addition to variations of the media described above for bioreactor motif. Conducted in sterile operation, chosen Petri plates growing anywhere from 3 to 90 days can be propagated into 4 L Erlenmeyer flasks (or 250 to 1,000 mL Wheaton jars) for incubation on a shaker table. The smaller the container, the faster the shaker should be. The inventors recommend anywhere from 40 to 160 RPM depending on container size, with about a 1″ swing radius. After shaking for 1 to 10 days, an aliquot (e.g. 10 to 500 mL) of the shake flask can be poured into a sterile, valved autoclavable container, which is then adjusted with sterile, room temperature glycerol to 40 to 60% (v/v). The glycerol stocks can be sealed with a water tight seal and can be placed into a sterile plastic bag, sealed, and placed into the freezer at −20° C. for storage and eventual cold shipping to any manufacturing site. The freezer is ideally a constant temperature freezer. Liquid tissue culture stocks not adjusted to glycerol may also be used and stored at 4° C. or −20° F. Glycerol stocks stored at 4° C. may also be used.

The present invention makes use of the concept that any human grade media, excluding any human grade ingredients discussed in the background, can be used as a media recipe for the production of edible liquid mycelial culture, as is known in the art and also disclosed elsewhere, e.g., PCT/US14/29989, filed Mar. 15, 2014, PCT/US14/29998, filed Mar. 15, 2014, U.S. 61/953,821, filed Mar. 15, 2014, U.S. 61/953,823, filed Mar. 15, 2014, U.S. 62/042,071, filed Aug. 26, 2014, all of which are incorporated by reference herein in their entireties. Preferably, a nitrogen salt, if used, is ammonium acetate, as it is the most ‘natural’ salt. Other supplemental media ingredients include brown rice syrup, molasses, fruit purees (mango, apple, etc.) in concentrations on the order of 1×10⁻² to 1×10² mL/L (or simply as the media), short grain brown rice flour, nutritional yeast flakes, carboxymethyl cellulose, carboxymethyl cellulose salts, whey, casein, and plant and seed protein. Ingredients are chosen so as to minimize possibilities for allergic reactions and provide high yield. Ammonium acetate is optionally incorporated as a batch fed ingredient.

The present invention may also be used with animal-grade media and animal grade food products.

In one embodiment, minimal media liquid tissue cultures are supplemented with large volumes of maximal media, so as to take advantage of short log times and secondary metabolism.

In one embodiment, a fungus strain useful for the fungal component of the present invention in one embodiment is C. sinensis strain WC859, commercially available from Pennsylvania State University (The Pennsylvania State University Mushroom Culture Collection, available from the College of Agriculture Sciences, Department of Plant Pathology and Environmental Microbiology, 117 Buckhout Laboratory, The Pennsylvania State University, University Park, Pa., USA 16802). Fungal components useful in the present invention may be prepared by methods described herein. Other methods known in the art may be used.

Alternatively, the fungal liquid tissue culture can include other species of fungi from genus Cordyceps, Ophiocordyceps, Elaphocordyceps, Metacordyceps, such as, for example, C. militaris. Many other species exist in the genus, however, these species are generally not cultivated commercially. However, it is expected that, for example, C. scarabaeicola, C. takaomontana, Ophiocordyceps dipterigena, Ophiocordyceps amazonica, C. cylindrica, Cordyceps sphecocephala, Metacordyceps martialis, Ophiocordyceps melonlonthae, Ophiocordyceps nutans, Ophiocordyceps curculionium, Ophiocordyceps australis, Ophiocordyceps tiputini, Cordyceps caloceroides, and Cordyceps variabilis will have the same or similar bitter blocking ability as C. sinensis.

Alternatively, fungi suitable for the present invention comprises: Ganoderma lucidum, Ganoderma applanatum, C. militaris, Hericium erinaceus, Lentinula edodes, Agaricus blazei, Grifola frondosa, Auricularia auricula, Flammulina velutipes, Trametes versicolor, Morchella spp., Inonotus obliquus, Laricifomes officinalis, Fomes fomentarius, Fomes officinalis, Fomes fomitopisis, Tricholoma matsutake, Boletus edulis, Clitocybe nuda, Clitocybe saeva, Plearotus spp., Tremella fuciformis, Piptoporus betulinis, Polyporus umbellatus, Pholiota nameko, Volvariella volvacea, Hypsizygus marmoreus, Stropharia rugosoannulata, Laetiporus sulfureus, and combinations thereof.

In one embodiment, the invention includes a method for preparing a extracellular portion of the mycelial aqueous culture after culturing. The extracellular portion includes mycelial biomolecular extracellular solids, cellular material and residual media of the mycelial aqueous culture.

As disclosed hereinabove, to prepare the culture, the prepared media is inoculated into a container of sterilized human grade media in water preferably filtered through any method known in the art, such as reverse osmosis, deionization or distillation. In another embodiment the water is not filtered. In another embodiment the media is animal grade. As disclosed, the flask and media can be sterilized by any method known in the art, such as in situ exposure to 250° F. at 23 PSI saturated steam for an appropriate amount of time, such as 2-2.5 hr for a 4.0 L Erlenmeyer flask filled with 1.5 L of media. The sterilized flask can be inoculated once cool by any means known in the art, such as by a Petri plate, floating or submerged liquid culture, myceliated agricultural material, glycerol stock, etc. The flask is ready for use after 3-60 days of appropriate culturing as is known in the art, such as on a shaker table at 130 RPM at room temperature in a cleanroom. A control Petri plate of the residual culture left in the flask can be made to ensure the flask is void of contamination. The flask can also be used to scale into a larger bioreactor (e.g. 5-500 L) made of the same quality media, which can be used in similar manner.

In some embodiments, the fungal liquid tissue culture is C. sinensis grown in a liquid media consisting of 8 g/L organic potato starch powder and 0.8 g/L organic carrot powder. This minimal medium has been found by the inventors to be an effective media recipe for producing the bitter blocker (taste enhancement food product) as previously described. The bitter blocking effect/taste enhancement of the product of the invention can be lost with different media, such as the addition of 20 g/L organic mango puree, which introduces flavor defects in an aqueous steviol glycoside solution. The resulting extracellular powder may be used as a bitter blocker in product applications as discussed herein.

After a suitable time for culturing, which can be determined by one of skill in the art, the extracellular portion (as defined herein) can be collected from the culture. This extracellular portion of the liquid mycelial aqueous culture may optionally be used to improve and/or enhance the taste of a food product comprising a protein concentrate or protein isolate. Culturing can take place, for example, for between about one and about sixty days, between about two and about fifty days, between about three and about forty days, between about four and about thirty days, between about five and about twenty-five days, between about six and about twenty days, between about seven and about fifteen days, between about eight and about twelve days, and between about nine and about ten days. The length of time for culturing can be determined by, for example, economic considerations for number of days in culture and the degree of taste enhancement observed for a particular culture time.

The culture to use in the present invention may be any liquid tissue culture comprising mycelium, for example, submerged or floating culture. A submerged culture is generally agitated, whereas the floating culture is minimally agitated, which allows the mycelia to grow in a mat-like form. The portions of the culture to use with the present invention includes any and all parts or portions of the culture, including mycelium, culture extracellular portion or filtrate, or any proportions or fractions thereof. In one embodiment, the culture may be blended (mechanically or otherwise) prior to use, and the entire blended material used, or some fraction thereof. In some embodiments, the portion of the culture to use is the portion of the culture which is commonly understood as the “cell culture extracellular portion” or “cell culture filtrate”, i.e., the fluid portion of the culture which has been separated from the mycelial cells, and contains a relatively smaller or lesser amount of mycelium as opposed to a mycelial cell portion, which is enriched in mycelial cells, but will still contain some fluid portion. Thus, it should be understood that this fluid tissue culture extracellular portion will also commonly contain mycelia, even if not visible to the eye or even easily visible under a microscope. This portion of the culture is called herein the “mycelial-free” portion for convenience, however, as stated it should be understood that this portion will commonly contain some minimal amount of mycelia, even if not visible to the eye.

In order to prepare the extracellular portion of the culture, the mycelium can be removed by any method known in the art to separate cell culture extracellular portion fluids. For example, the culture may be filtered by any means known in the art to obtain the filtrate, such as, for example, 0.2 μm filters and the like. Alternatively, the extracellular portion of the culture may be collected by centrifugation. The collected extracellular portion of the cultured mycelial aqueous culture may be referred to herein as collected extracellular portion, extracellular portion, extracellular portion fluid, C. sinensis supernatant, filtrate, product, and similar terms such as the taste-enhancing product or bitter blocker/blocking product, or bitter blocker.

Optionally, the liquid tissue culture can be treated to reduce or eliminate the viability of live organisms, such as pasteurization or sterilization, by methods known in the art. The collected liquid tissue culture may be pasteurized or sterilized either before or after separation to obtain the extracellular portion of the culture, by any method known in the art. In one embodiment the material is sterilized under conditions such as approximately 30 to 50 minute exposure to 250° F. saturated steam at 23 psi. Alternatively, the material can be pasteurized by holding the material in a hot water bath at 160 to 170° F. for 20 minutes, twice, cooling it back to room temperature in between runs.

This pasteurized or sterilized liquid tissue culture could be used as a novel beverage, or its powder as a novel foodstuff, food ingredient, dietary supplement, dietary ingredient or food additive which can be used from 0.1-40,000 ppm in various product applications.

The filtrate (collected extracellular portion) e.g., extracellular portion of a mycelial aqueous culture may have its volume or liquid component adjusted as determined by one of skill in the art to produce concentrates, diluates, or dried powders. In one embodiment, the filtrate may be optionally dried by any method known in the art, including the use of open air drying, small batch desiccators, vacuform dryers, fluid beds or spray dryers, or freeze-driers to dry the liquid to a powder. The filtrate is, in one embodiment, dried following sterilization/pasteurization.

The resulting powder or taste enhancement product may be used to enhance the taste of a food product comprising a protein concentrate or protein isolate, and may be mixed into any food/beverage as described herein at concentrations of 0.1-40,000 ppm and even higher depending on the nature of the application Determination of the amount of the taste enhancement product to use may be determined by one of skill in the art by trial with the goal to reduce or eliminate undesirable taste component in the food product comprising a protein concentrate or protein isolate and/or enhance the food product comprising a protein concentrate or protein isolate's taste, without introducing flavor defects.

A general range of concentrations of C. sinensis extracellular portion (bitter blocker) as a dried powder to use with various food products is shown in Table 9 below. It is within the skill in the art to determine optimum ratios of the C. sinensis extracellular portion to use with a particular product, based on taste profiles. For example, at too high concentrations of C. sinensis extracellular portion, the flavor enhancing effect will cease to be or the product will introduce flavor defects into the final material. At too low of a concentration of extracellular portion, there will be an insufficient degree of taste improvement. For example, serial dilution/concentration can be used as a tool in determining the upper and lower threshold concentrations use of the extracellular portion. Formulate the bitter blocker into the material at whatever initial desired concentration one wants to test. If it provides the desired flavor change, halve the concentration until the flavor change is insufficient. Take the final concentrations between what worked and what did not, and apply the bitter blocker at the average. If it works, halve the concentration until it no longer works, and the concentration above the one that doesn't work is the lower threshold concentration. If it doesn't work, double the concentration until it does. The lower threshold concentration can be doubled indefinitely to reach the upper threshold concentration, wherein the taster determines whether the flavor modifying effect is eventually lost or the bitter blocker starts to introduce a flavor defect.

The powder may also be rehydrated, filtered and re-dried to increase solubility of the product. The spray dried product has high solubility and optionally is not rehydrated before use, and may be simply mixed in as a powder with a food product comprising a protein concentrate or protein isolate (particularly in non-nutritive sweetener applications). Alternatively, the extracellular portion may be combined with a food product comprising a protein concentrate or protein isolate in liquid form, and optionally the food product/taste enhancement product may be dried together. The extracellular portion powder may also be dried in a fluid bed, or spray dried onto a fluidized product and even agglomerated, such as in the production of a steviol glycoside mixture comprising the product.

The present invention includes a bitter blocker product made by the methods disclosed herein.

The present invention offers an effective means of culturing mycelium around the world as human food by means of presenting the inoculant source at a production site in the form of a liquid tissue stock adjusted to 50% (v/v) glycerol, which can be maintained at −20° C. This culture, at least for both strains tested (G. lucidum and C. sinensis), display the phenomenon of increasing in vigor upon revival the longer it is kept in −20° C. storage, and does not need to be warmed up before propagation.

The present invention also provides for a method to produce a food product comprising a protein concentrate or protein isolate, comprising culturing a mycelial aqueous culture in a media, collecting the extracellular portion of the supernatant, and using the extracellular portion of the culture as the bitter blocker of the present invention. Appropriate fungi to use, appropriate media, appropriate methods of collecting the extracellular portion of the supernatant are disclosed herein. The extracellular portion of the culture fluid (or conditioned media) can be used on its own as a food or flavor additive. The extracellular portion may be optionally concentrated, diluted or dried as disclosed herein, and may be combined with any food product comprising a protein concentrate or protein isolate as disclosed herein prior to use. The present invention also includes combination products comprising one or more food product(s) comprising a protein concentrate or protein isolate and extracellular portion made from a mycelial aqueous culture made by the processes disclosed herein.

Therefore, in another embodiment, provided is a composition comprising a combination of one or more food products comprising a protein concentrate or protein isolate, and a extracellular portion from a mycelial aqueous culture. In one embodiment, the mycelial aqueous culture is produced by methods of the present invention.

In one embodiment, the extracellular portion. from a mycelial aqueous culture is a dried or partially dried filtrate or extracellular portion from the mycelial aqueous culture. The composition may include the extracellular portion of a mycelial aqueous culture obtained from a fungus as previously defined herein, and may include, for example, Cordyceps sinensis, and/or Cordyceps militaris.

The extracellular portion of the mycelial aqueous culture may be obtained by any methods known in the art, including methods disclosed herein. Such methods include the steps of culturing a mycelial aqueous culture in a media, separating the mycelium-free fluid from the mycelial cells, and collecting the mycelium-free fluid as the extracellular portion of the mycelial aqueous culture.

The composition, in some embodiments, has a taste enhancement which includes reduced bitter tastes, reduced undesirable aftertastes, reduced metallic tastes, and/or reduced astringency compared to the food product alone.

Compositions may be formed from food product comprising a protein concentrate or protein isolates that are dried prior to combination with the extracellular portion of a mycelial aqueous culture. In some embodiments, prior to combination with a food product, the extracellular portion of a mycelial aqueous culture is dried. Thus, a dried food product may be combined with a dried extracellular portion of a mycelial aqueous culture to form the composition.

Additional components that may be included in compositions of the invention include for example, non-nutritive sweeteners and nutritive sweeteners. These include, without limitation, non-nutritive sweeteners such as mogroside, mogroside mixtures, aspartame, acesulfame-k, sucralose, steviol glycoside mixtures, stevia plant parts, and combinations thereof. Another category of additional components includes, for example, whole wheat, coffee, tea, amaranth, quinoa, pea protein, monk fruit, monk fruit extract, beer, liquor, spirits, wine, sucralose, carbohydrates, potassium chloride, cacao, cacao liquor, ginseng, sugar alcohol, cranberry, grapefruit, pomegranate, and coconut.

Also, food products include food products comprising protein concentrates and/or isolates, e.g., concentrates or isolates which comprise at least 50% protein. Such a protein concentrate or isolate can be obtained from a number of sources, including vegetarian sources as well as non-vegetarian sources. Vegetarian sources include protein concentrates and isolates prepared from a vegetarian source such as pea, rice, soy, hemp, and other sources, or a combination thereof. Typically a protein concentrate is made by removing the oil and most of the soluble sugars from a meal made of the starting material, such as soybean meal. A protein concentrate may still contain a significant portion of non protein material, such as fiber. Typically, protein concentrations in a concentrate are between 65-90%. A protein isolate typically removes most of the non-protein material such as fiber and may contain up to about 90% protein. A protein isolate is typically dried and is available in powdered form and may alternatively called “protein powder.” The protein isolate or concentrate may have a proximate analysis for protein with a protein amount comprising at least 20% protein, 30% protein, 40% protein, 45% protein, 50% protein, 55% protein, 60% protein, 65% protein, 70% protein, 75% protein, 80% protein, 85% protein, 90% protein, 95% protein, or 98% protein, or at least about 20% protein, at least about 30% protein, at least about 40% protein, at least about 45% protein, at least about 50% protein, at least about 55% protein, at least about 60% protein, at least about 65% protein, at least about 70% protein, at least about 75% protein, at least about 80% protein, at least about 85% protein, at least about 90% protein, at least about 95% protein, or at least about 98% protein.

Vegetarian sources of protein have some advantages over non-vegetarian sources of protein. Whey or casein protein isolates will also contain some amount of lactose and can cause difficulties for those who are lactose-intolerant. Egg protein isolates may cause problems in those who are allergic to eggs and are also quite expensive. Soy protein isolates contain all of the essential amino acids and is inexpensive. Rice protein is easily digestible but is deficient in some amino acids and therefore does not provide a “complete” protein. Hemp protein is a complete protein, and pea protein, while containing all essential amino acids, does not contain them in the correct ratios. In one embodiment, the food product comprises a protein, such as a protein concentrate or isolate. Such protein concentrates or isolates can include protein concentrates or isolates from any source, and includes, for example, pea protein concentrate, pea protein isolate, potato protein, soy protein, rice protein, brown rice protein, whey isolate, wheat gluten, blends of soy, wheat, pea powder; also included are protein concentrates or isolates such as hemp protein, oat protein, duckweed protein, cyanobacteria, grain, chia, chickpea, potato protein, algal protein and nettle protein or combinations of these. Other sources of protein, including lower quality sources such as, corn gluten meal, may also be used. Other proteins may be used (which may or may not be in the form of isolates or concentrates) include single cell proteins such as those derived from bacterial or fungal organisms, including Neurospora, such as N. intermedia or N. crassa, Aspergillus such as A. oryzae, Fusarium such as F. venentum or F. oxysporum, or filamentous fungi such as Pleurotus (including P. ostreatus), Lentinula (including L. edodes), Morchella (including M. esculenta).

The protein concentrate or isolate may also be obtained from non-vegetarian sources, such as egg, whey, casein, beef, and/or combinations thereof. Alternatively, the methods of the invention can be used with concentrated protein powders made from pea, rice, soy, hemp, whey, casein, egg and the like, and hydrolyzed forms of same and combinations thereof.

Food compositions of the present invention also include combinations of a food product comprising a protein concentrate or isolate, together with the extracellular portion of the present invention.

The extracellular portion can be used together with a protein concentrate or isolate to create a number of food compositions, including, without limitation, dairy alternative products, beverages and beverage bases, extruded and extruded/puffed products, meat imitations and extenders, baked goods and baking mixes, granola products, bar products, smoothies and juices, and soups and soup bases, all of which contain an extracellular portion according to the invention. The invention includes methods to make food compositions, comprising providing a food product comprising a protein concentrate or isolate, providing an extracellular portion, and mixing. Additional ingredients in the food composition can be, without limitation, a starch, a flour, a grain, a lipid, a colorant, a flavorant, an emulsifier, a sweetener, a vitamin, a mineral, a spice, a fiber, a protein powder, nutraceuticals, sterols, isoflavones, lignans, glucosamine, an herbal extract, xanthan, a gum, a hydrocolloid, a starch, a preservative, a legume product, a food particulate, and combinations thereof. A food particulate can include cereal grains, cereal flakes, crisped rice, puffed rice, oats, crisped oats, granola, wheat cereals, protein nuggets, texturized plant protein ingredients, flavored nuggets, cookie pieces, cracker pieces, pretzel pieces, crisps, soy grits, nuts, fruit pieces, corn cereals, seeds, popcorn, yogurt pieces, and combinations of any thereof.

The methods to prepare a food composition can include the additional, optional steps of cooking, extruding, and/or puffing the food composition according to methods known in the art to form the food compositions of the invention.

In one embodiment, the food composition can include an alternative dairy product comprising a food product comprising a protein concentrate or protein isolate according to the invention. An alternative dairy product according to the invention includes, without limitation, products such as imitation skimmed milk, imitation whole milk, imitation cream, imitation cream filling, imitation fermented milk product, imitation cheese, imitation yogurt, imitation butter, imitation dairy spread, imitation butter milk, imitation acidified milk drink, imitation sour cream, imitation ice cream, imitation flavored milk drink, or an imitation dessert product based on milk components such as custard. Methods for producing alternative dairy products using alternative proteins, such as plant-based proteins as disclosed herein including nuts (almond, cashew), seeds (hemp), legumes (pea), rice, and soy are known in the art.

The present invention can also include extruded and/or puffed products and/or cooked products made with compositions of the invention. Extruded and/or puffed ready-to-eat breakfast cereals and snacks are known in the art. Extrusion processes are well known in the art and appropriate techniques can be determined by one of skill. These materials are formulated primarily with cereal grains and may contain flours from one or more cereal grains. The composition of the present invention contain flour from at least one cereal grain, preferably selected from corn and/or rice, or alternatively, wheat, rye, oats, barley, and mixtures thereof. The cereal grains used in the present invention are commercially available, and may be whole grain cereals, but more preferably are processed from crops according to conventional processes for forming refined cereal grains. The term “refined cereal grain” as used herein also includes derivatives of cereal grains such as starches, modified starches, flours, other derivatives of cereal grains commonly used in the art to form cereals, and any combination of such materials with other cereal grains.

The food products produced using the methods described herein can be in the form of crunchy curls, puffs, chips, crisps, crackers, wafers, flat breads, biscuits, crisp breads, protein inclusions, cones, cookies, flaked products, fortune cookies, etc. The food product can also be in the form of pasta, such as dry pasta or a ready-to-eat pasta. The product can be used as or in a snack food, cereal, or can be used as an ingredient in other foods such as a nutritional bar, breakfast bar, breakfast cereal, or candy. In a pasta, the one myceliated low-quality protein compositions may be, in a non-limiting example, be used in levels of about 10 g per 58 g serving (17%).

A food composition of the invention can also include a texturized protein, such as a texturized plant protein. Texturized plant protein comprising the myceliated low-quality protein compositions of the present invention include meat imitation products and methods for making meat imitation products comprising the myceliated low-quality protein compositions as disclosed within. The myceliated low-quality protein compositions analog meat products can be produced with high moisture content and provide a product that simulates the fibrous structure of animal meat and has a desirable meat-like moisture, texture, mouthfeel, flavor and color. Methods for making such products using plant-based proteins such as pea protein, soy protein and the like are known in the art and such methods may be used in the instant invention. Texturization of protein is the development of a texture or a structure via a process involving heat, and/or shear and the addition of water. The texture or structure will be formed by protein fibers that will provide a meat-like appearance and perception when consumed. To make non-animal proteins palatable, texturization into fibrous meat analogs, for example, through extrusion processing has been an accepted approach. Due to its versatility, high productivity, energy efficiency and low cost, extrusion processing is widely used in the modern food industry. Extrusion processing is a multi-step and multifunctional operation, which leads to mixing, hydration, shear, homogenization, compression, deaeration. pasteurization or sterilization, stream alignment, shaping, expansion and/or fiber formation. In one embodiment, the texturized protein is rehydrated in water containing or comprising the extracellular portion, as shown in the Examples.

Food compositions comprising the compositions of the invention include, for example, bakery products and baking mixes. The term “bakery product” includes, but is not limited to leavened or unleavened, traditionally flour-based products such as white pan and whole wheat breads (including sponge and dough bread), cakes, pretzels, muffins, donuts, brownies, cookies, pancakes, biscuits, rolls, crackers, pie crusts, pizza crusts, hamburger buns, pita bread, and tortillas.

Food compositions comprising the compositions of the invention also include, for example, spreads, pastes such as sweet (e.g. chocolate or fruit) pastes or savory pastes, prewhipped toppings, custards, coatings, peanut butter, frostings, cream filings, confectionery fillings and other confectioneries.

The present invention also includes food compositions such as granola cereals, and bar products, including such as granola bars, nutrition bars, energy bars, sheet and cut bars, extruded bars, baked bars, and combinations thereof.

The baked food compositions and bar compositions are generally formed dependent on the desired end product. The baked food compositions and bar compositions are produced according to standard industry recipes.

In one embodiment, the invention includes preparation of spreads that have increased nutritional content, for example a relatively high protein content. The nutritional paste includes compositions of the present invention, together with fats and emulsifiers to form said paste; wherein the paste has a low water activity and low pH to substantially prevent bacterial growth and enable the paste to be stable without being stored at 4° C.

A food product comprising a protein concentrate or protein isolate may also include products taken by mouth, such as dietary supplements, vitamins, food additives, pharmaceuticals, and nutraceuticals. Many of these types of products have unpleasant tastes, including caffeine and polyphenols, calcium, vitamins, cough syrups, probiotics, and the like. Vitamins include vitamin A, vitamin D, vitamin E (e.g., d-alpha-tocopherol, d-alpha-tocopheryl acetate, dl-alpha-tocopherol and dl-alpha-tocopheryl acetate), vitamin B1 and derivatives thereof, vitamin B2 and derivatives thereof, vitamin B6 and derivatives thereof (e.g., pyridoxine hydrochloride), vitamin C and derivatives thereof (e.g., ascorbic acid, sodium L-ascorbate, etc.), vitamin B12 and derivatives thereof, fluoride (e.g., sodium fluoride), calcium, magnesium, iron, proteins, amino acids, amino saccharides (amino sugars), oligosaccharides, and combinations thereof.

Pharmaceuticals may include drugs or quasi-drugs that are administered orally or used in the oral cavity (e.g., vitamins, cough syrups, cough drops, chewable medicine tablets, amino acids, bitter-tasting agents, acidulants or the like), wherein the drug may be in solid, liquid, gel, or gas form such as a pill, tablet, spray, capsule, syrup, drop, troche agent, powder, and the like; personal care products such as other oral compositions used in the oral cavity such as mouth freshening agents, gargling agents, mouth rinsing agents, toothpaste, tooth polish, dentrifices, mouth sprays, teeth-whitening agent and the like; dietary supplements; animal feed; nutraceutical products, which includes any food or part of a food that may provide medicinal or health benefits, including the prevention and treatment of disease (e.g., cardiovascular disease and high cholesterol, diabetes, osteoporosis, inflammation, or autoimmune disorders), non-limiting, examples of nutraceuticals include naturally nutrient-rich or medicinally active food, such as garlic, soybeans, antioxidants, fibers, phytosterols and phytostanols and their esters, glucosamine, chondroitin sulfate, stenol, stanol, ginseng, ginko, echinacea, or the like; other nutrients that provide health benefits, such as amino acids, vitamins, minerals, carotenoids, dietary fiber, fatty acids such as omega-3 or omega-6 fatty acids, DHA, EPA, or ALA which can be derived from plant or animal sources (e.g., salmon and other cold-water fish or algae), flavonoids, phenols, polyols, polyphenols (e.g., catechins, proanthocyanidins, procyanidins, anthocyanins, quercetin, resveratrol, isoflavones, curcumin, punicalagin, ellagitannin, citrus flavonoids such as hesperidin and naringin, and chlorogenic acid), prebiotics/probiotics, phytoestrogens, sulfides/thiols, policosanol, saponin, rubisco peptide, appetite suppressants, hydration agents, autoimmune agents, C-reactive protein reducing agents, or anti-inflammatory agents; or any other functional ingredient that is beneficial to the treatment of specific diseases or conditions, such as diabetes, osteoporosis, inflammation, or high cholesterol levels in the blood.

The following examples are provided for illustrative purposes only and are not intended to limit the scope of the invention.

### EXAMPLES

### Example 1

An RO filtered aqueous extract was made from 1 lb. of organic/fresh potato and carrot, and 1 L of organic fruit juice to create 1 L cultures in 6, 4 L Erlenmeyer flasks. These cultures were made with anywhere from 0-100% stevia/tea aqueous extract. The flasks were autoclaved and cooled. Once cool, a log phase Petri plate culture of C. sinensis WC859 was propagated into the flask and subsequently agitated (60 RPM with a ½ inch swing radius). A fully developed liquid tissue culture (growing in log phase) was observed in about 3-4 days. 20 g of stevia leaf was placed in a food-grade container and about 100 mL of log phase liquid culture as described above was added to the container. The container was allowed to incubate, covered, at about 75 degrees F. for about six hours. After incubation the stevia leaves were lightly pasteurized and dried. 5 g of the treated stevia leaves were soaked in one cup of water, filtered and tasted in a randomized double-blind test with untreated stevia by five testers. The testers found that the treated stevia had increased sweetness compared to untreated control stevia and had a mitigated bitter/licorice aftertaste.

### Example 2

An RO filtered aqueous extract was made from 1 lb. of organic/fresh potato and carrot, and 1 L of organic fruit juice to create 6, 1 L cultures in 4 L Erlenmeyer flasks. These cultures were made with 0-100% aqueous tea extract. The flasks were autoclaved and cooled. Once cool, a log phase Petri plate culture of C. sinensis strain WC859 was propagated into the flask and subsequently agitated (60 RPM with a ½ inch swing radius). A fully colonized log-phase liquid tissue culture was observed in about 3-4 days. Approximately 20 g of green tea leaves were placed in a food-grade container and about 100 mL of log phase culture as described above was added to the container. The container was allowed to incubate, covered, at about 75 degrees F. for about six hours. After the incubation was finished, according to taste testing, the green tea leaves were lightly rinsed, mildly pasteurized, and dried. 5 g of the treated green tea leaves were dried and brewed in one cup of water, filtered and tasted in a randomized, double-blind test with untreated control green tea leaves by five testers. The testers found that the treated green tea leaves had decreased bitterness compared to the control green tea leaves.

### Example 3

A clean, 1.5 L handled glass bottle was filled with 1 L of media consisting of 17 g/L agar, 8 g/L organic potato starch, 0.8 g/L organic carrot powder, and 20 mL/L organic mango puree. The lid of the handled glass bottle was loosely screwed on and covered with tin foil. The inventors recommend the use of these handled glass bottles due to their handles, which make pouring easier. The bottle was placed in an autoclave and sterilized on a 2.33 hour liquid cycle. Once the cycle was complete, the bottle was quickly placed in a laminar sterile flow hood to cool until it could be touched, which took about 1.3 hours. At this point, the contents of the bottle were carefully poured into 120 Petri plates. The plates cooled overnight in the hoods.

Once cool, fungi from stock cultures were used to inoculate the recently poured plates. These fungi were growing on an identical media. The fungi were transferred with sterile 12″ bamboo skewers which had been autoclaved in a mason ball jar with the agar from the previous day. One of these species of fungus was Hericium erinaceus. 15 H. erinaceus plates were made and one was selected for propagation into a 4 L Erlenmeyer flask 8 days after propagation. On the 7^{th} day of growth, the 4 L Erlenmeyer flask was prepared. The flask contained 1.5 L of media, consisting of 8 g/L corn flour, 4 g/L organic oat flour, 2 g/L organic mango puree and 2 g/L organic potato starch powder. The flask shook at 60 RPM for 6 days on a 1″ swing radius. On the 2^{nd} day of this culture, a 100 L bioreactor was filled with 58 L of RO water, and a concentrate containing 800 g organic potato starch powder, 80 g organic carrot powder, 50 g blended organic soft white wheat berries and 1 L organic mango puree, adjusted to 2 L with RO water, was poured into the reactor to bring the volume to 60 L. The reactor was not jacketed so 121 to 122° C. was injected and vented into the chamber through manifolds connected to the pressure vessel head set up by one of skill in art. The bioreactor was sterilized on a 4.5 hour liquid cycle, and filled to 85 L due to steam condensation. The reactor cooled to room temperature for four days through thermal diffusion, at which point it was inoculated.

The vessel had access to an air-inlet line, which comprised a ¼ horsepower, 115 V, 50/60 Hz air compressor supplying air through two in-inline 0.2 μm autoclavable capsule filters, through a check-valve and ball-valve into the chamber. The entire capsule filter valve set-up was sterilized before sterilizing the bioreactor and media, and assembled onto the bioreactor in sterile operation. Once cool after 86 hours, air was run to pressurize the vessel, but instead of running through an air exhaust manifold, the air exhaust manifold was closed and a pressure gauge on the head of the vessel immediately removed so as to create a positively pressured nozzle. The lid of the submerged H. erinaceus culture was removed, the top 5 inches of the Erlenmeyer flask flamed down with a propane torch by one of skill in the art, and, once the flask is cool (an 8 second wait time), the flask was poured into the bioreactor through the positively pressured nozzle. The pressure gauge was placed back onto the reactor, and the air exhaust manifold immediately opened. The reactor pressure equilibrated at 2-3 psi, the cracking pressure of the entry and exit check-valves. Petri plates of the H. erinaceus inoculant were made for QC.

Air was supplied as such, and the bioreactor cultured for 13 days. The culture appeared to enter log phase on day 2, and grew vibrantly with 0.5 cm spheres until day 9, where cell division appeared to stop. On the 13^{th} day, the contents of the bioreactor were poured into a 6 m² plastic tub with 10 inch walls with lips, the tub being coated with food-grade plastic sheeting. The tub was kept at a height of about 4 feet, and two fans were positioned to blow air over the tub. After four days, the culture had dried, and a beef jerky like material was recovered and blended to yield 724 g of powder. The powder had a very light carrot taste, and primarily a cereal-esque taste that was very neutral.

### Example 4

A 4 L flask filled with 1.5 L of 8 g/L organic potato starch and 0.8 g/L organic carrot powder in RO water was sterilized and inoculated from a two week old P1 C. sinensis culture. After culturing for 7 days at room temperature at 60 RPM (1″ swing radius), the culture was filtered through three stacked coffee filters, pasteurized for 40 minutes at 165° F. and placed in a small batch desiccator at 140° F. overnight. The following day the dried material was collected and blended with a yield of 4.5 g/L for a total of 6.75 g. 5 g of the harvested material was poured into 1 L of RO water and shaken intermittently for 15 minutes. From this stock culture, 53.34 mL of solution was added to another solution containing 1 kg of 97% rebaudioside A dissolved in 1.6 L of RO water. This solution was thoroughly mixed and dried in a small batch desiccator overnight, and the resulting material was blended and packaged in a clean ziplock bag, having a concentration of the collected filtrate solids of 2,667 ppm. 150 mg of this mixture was added to 500 mL of RO water to create a solution of 300 ppm 97% rebaudioside A to 0.8 ppm C. sinensis extracellular portion solids. When taste tested against a control, it was obvious to all three inventors that the aftertaste of the steviol glycoside mixture containing the C. sinensis extracellular portion solids was undetectable compared to a control 300 ppm 97% rebaudioside A solution.

### Example 5

A 4 L flask filled with 1.5 L of 8 g/L organic potato starch and 0.8 g/L organic carrot powder in RO water was sterilized and inoculated from a two week old P1 C. sinensis culture. After culturing for 15 days at room temperature at 60 RPM (1″ swing radius), the culture was filtered through three stacked coffee filters, pasteurized for 40 minutes at 165° F. and placed in a small batch desiccator at 140° F. overnight. The following day the dried material was collected and blended with a yield of 4.1 g/L for a total of 6.15 g. 5 g of the harvested material was poured into 1 L of RO water and shaken intermittently for 15 minutes. From this stock culture, 53.34 mL of solution was added to another solution containing 1 kg of 97% rebaudioside A dissolved in 1.6 L of RO water. This solution was thoroughly mixed and dried in a small batch desiccator overnight, and the resulting material was blended and packaged in a clean ziplock bag, having a concentration of the collected filtrate solids of 2,667 ppm. 150 mg of this mixture was added to 500 mL of RO water to create a solution of 300 ppm 97% rebaudioside A to 0.8 ppm C. sinensis extracellular portion solids. When taste tested against a control, it was obvious to all three inventors that the aftertaste of the steviol glycoside mixture containing the C. sinensis extracellular portion solids was undetectable compared to a control 300 ppm 97% rebaudioside A solution.

### Example 6

A 4 L flask filled with 1.5 L of 8 g/L organic potato starch and 0.8 g/L organic carrot powder in RO water was sterilized and inoculated from a two week old P1 C. sinensis culture. After culturing for 35 days at room temperature at 60 RPM (1″ swing radius), the culture was filtered through three stacked coffee filters, pasteurized for 50 minutes at 165° F. and placed in a small batch desiccator at 140° F. overnight. The following day the dried material was collected and blended with a yield of 5.5 g/L for a total of 8.25 g. 5 g of the harvested material was poured into 1 L of RO water and shaken intermittently and heated on a hot plate turned to medium for 15 minutes. From this stock culture, 53.34 mL of solution was added to another solution containing 1 kg of 97% rebaudioside A dissolved in 1.6 L of RO water. This solution was thoroughly mixed and dried in a small batch desiccator overnight, and the resulting material was blended and packaged in a clean ziplock bag, having a concentration of the collected filtrate solids of 2,667 ppm. 150 mg of this mixture was added to 500 mL of RO water to create a solution of 300 ppm 97% rebaudioside A to 0.8 ppm C. sinensis extracellular portion solids. When tasted against a control, it was obvious to all three inventors that the aftertaste of the steviol glycoside mixture containing the C. sinensis extracellular portion solids was undetectable compared to a control 300 ppm 97% rebaudioside A solution.

### Example 7

A 4 L flask filled with 1.5 L of 8 g/L organic potato starch and 0.8 g/L organic carrot powder in RO water was sterilized and inoculated from a two week old P1 C. sinensis culture. After culturing for 7 days at room temperature at 60 RPM (1″ swing radius), the culture was filtered through cheesecloth, pasteurized for 50 minutes at 160° F. and placed in a small batch desiccator at 130° F. overnight. The following day the dried material was collected and blended with a yield of 4.4 g/L for a total of 6.6 g. 5 g of the harvested material was poured into 1 L of RO water and shaken intermittently for 15 minutes. From this stock culture, 53.34 mL of solution was added to another solution containing 1 kg of 97% rebaudioside A dissolved in 1.6 L of RO water. This solution was thoroughly mixed and dried in a small batch desiccator overnight, and the resulting material was blended and packaged in a clean ziplock bag, having a concentration of the collected filtrate solids of 2,667 ppm. 150 mg of this mixture was added to 500 mL of RO water to create a solution of 300 ppm 97% rebaudioside A to 0.8 ppm C. sinensis extracellular portion solids. When taste tested against a control, it was obvious to all three inventors that the aftertaste of the steviol glycoside mixture containing the C. sinensis extracellular portion solids was undetectable compared to a control 300 ppm 97% rebaudioside A solution.

### Example 8

A 4 L flask filled with 1.5 L of 8 g/L organic potato starch and 0.8 g/L organic carrot powder in RO water was sterilized and inoculated from a two week old P1 C. sinensis culture. After culturing for 10 days at room temperature at 60 RPM (1″ swing radius), the culture was filtered through three stacked coffee filters, pasteurized for 40 minutes at 170° F. and placed in a small batch desiccator at 140° F. overnight. The following day the dried material was collected and blended with a yield of 4.6 g/L for a total of 6.9 g. 5 g of the harvested material was poured into 1 L of RO water and shaken intermittently for 15 minutes. From this stock culture, 40.00 mL of solution was added to another 1.6 L solution of distilled water containing 1 kg of 97% rebaudioside A. This solution was thoroughly mixed and dried in a small batch desiccator overnight, and the resulting material was blended and packaged in a clean ziplock bag, having a concentration of the collected filtrate solids of 2,000 ppm. 150 mg of this mixture was added to 500 mL of RO water to create a solution of 300 ppm 97% rebaudioside A to 0.6 ppm C. sinensis extracellular portion solids. When taste tested against a control, it was obvious to all three inventors that the aftertaste of the steviol glycoside mixture containing the C. sinensis extracellular portion solids was undetectable compared to a control 300 ppm 97% rebaudioside A solution. This steviol glycoside mixture tasted very similar to the mixture containing 0.8 ppm extracellular portion solids.

### Example 9

A 4 L flask filled with 1.5 L of 8 g/L organic potato starch and 0.8 g/L organic carrot powder in RO water was sterilized and inoculated from a 10 day old P1 C. sinensis culture. After culturing for 4 days at room temperature at 60 RPM (1″ swing radius), the culture was filtered through cheesecloth and placed in a small batch desiccator at 140° F. overnight. The following day the dried material was collected and blended with a yield of 4.5 g/L for a total of 6.75 g. 5 g of the harvested material was poured into 1 L of RO water and shaken intermittently for 15 minutes. From this stock culture, 53.34 mL of solution was added to another solution containing 1 kg of 97% rebaudioside A dissolved in 1.6 L of RO water. This solution was thoroughly mixed and dried in a small batch desiccator overnight, and the resulting material was blended and packaged in a clean ziplock bag, having a concentration of the collected filtrate solids of 2,667 ppm. 150 mg of this mixture was added to 500 mL of RO water to create a solution of 300 ppm 97% rebaudioside A to 0.8 ppm C. sinensis extracellular portion solids. When taste tested against a control, it was obvious to all three inventors that the aftertaste of the steviol glycoside mixture containing the C. sinensis extracellular portion solids was undetectable compared to a control 300 ppm 97% rebaudioside A solution.

### Example 10

A 4 L flask filled with 1.5 L of 8 g/L organic potato starch and 0.8 g/L organic carrot powder in RO water was sterilized and inoculated from a two week old P1 C. sinensis culture. After culturing for 7 days at room temperature at 60 RPM (1″ swing radius), the culture was filtered through three stacked coffee filter and placed in a small batch desiccator at 140° F. overnight. The following day the dried material was collected and blended with a yield of 4.5 g/L for a total of 6.75 g. 5 g of the harvested material was poured into 1 L of RO water and shaken intermittently for 15 minutes. From this stock culture, 53.34 mL of solution was added to another solution containing 1 kg of 60% rebaudioside A dissolved in 1.6 L of RO water. This solution was thoroughly mixed and dried in a small batch desiccator overnight, and the resulting material was blended and packaged in a clean ziplock bag, having a concentration of the collected filtrate solids of 2,667 ppm. 150 mg of this mixture was added to 500 mL of RO water to create a solution of 300 ppm 60% rebaudioside A to 0.8 ppm C. sinensis extracellular portion solids. When taste tested against a control, it was obvious to all three inventors that the aftertaste of the steviol glycoside mixture containing the C. sinensis extracellular portion solids was undetectable compared to a control 300 ppm 60% rebaudioside A solution.

### Example 11

A 4 L flask filled with 1.5 L of 8 g/L organic potato starch and 0.8 g/L organic carrot powder in RO water was sterilized and inoculated from a 20 day old P1 C. sinensis culture. After culturing for 7 days at room temperature at 60 RPM (1″ swing radius), the culture was filtered through a 0.2 μm vacuum filter and placed in a small batch desiccator at 150° F. overnight. The following day the dried material was collected and blended with a yield of 4.3 g/L for a total of 6.45 g. 5 g of the harvested material was poured into 1 L of RO water and shaken intermittently for 15 minutes. From this stock culture, 53.34 mL of solution was added to another solution containing 1 kg of 60% rebaudioside A dissolved in 1.6 L of RO water. This solution was thoroughly mixed and dried in a small batch desiccator overnight, and the resulting material was blended and packaged in a clean ziplock bag, having a concentration of the collected filtrate solids of 2,667 ppm. 150 mg of this mixture was added to 500 mL of RO water to create a solution of 300 ppm 60% rebaudioside A to 0.8 ppm C. sinensis extracellular portion solids. When taste tested against a control, the aftertaste of the steviol glycoside mixture containing the C. sinensis extracellular portion solids was undetectable compared to a control 300 ppm 60% rebaudioside A solution.

### Example 12

16 different media recipes to determine the effect of media on bitter blocking activity against a sample of 60% rebaudioside A using the method of Example 4, while varying media as shown below. Table 1 below shows what media were tested and the sensory response summaries.

TABLE 1
Effect of Media on Bitter Blocking Activity
against 60% rebaudioside A*

| Media Recipe | Result |
|---|---|
| Nutritional Yeast | No stevia aftertaste, though introduced a new |
| | undesirable aftertaste |
| Brown Rice Syrup | No aftertaste, typical up front flavor, no |
| | new flavors introduced |
| Corn & Oat Flours | No aftertaste, very nice up front stevia flavor |
| | no new flavors introduced |
| Potato Starch Powder | No aftertaste, typical up front stevia flavor, no |
| | new flavors introduced |
| Barley Flour | No aftertaste, duller up front stevia flavor, no |
| | new flavors introduced |
| Kelp | No aftertaste, muted up front stevia flavor, no |
| | new flavors introduced |
| Green Tea | No aftertaste, introduces a tea flavor defect up |
| | front |
| Carrot Powder | No aftertaste, nice up front stevia flavor, no |
| | new flavors introduced |
| Brown Rice Flour | No aftertaste, nice up front stevia flavor, no |
| | new flavors introduced |
| Blackstrap Molasses | No aftertaste, mild up front stevia flavor, no |
| | new flavors introduced |
| Sodium | No aftertaste, mild up front stevia flavor, |
| Carboxymethylcellulose | no new flavors introduced |
| Wheat Flour | No aftertaste, dull up front stevia flavor, |
| | no new flavors introduced |
| Rye Flour | No aftertaste, dull up front stevia flavor, |
| | no new flavors introduced |
| Oat Flour | No aftertaste, dull up front stevia flavor, |
| | no new flavors introduced |
| Corn Flour | No aftertaste, mild up front stevia flavor, |
| | no new flavors introduced |

*All media made with 8 g/L of material, the corn/oat sample being made with 5 g/L and 3 g/L respectively. Product was tasted at 300 ppm 60% reb A and 0.8 ppm supernatant powder.

Table 1 shows that many recipes are applicable to the production of the bitter blocker though not every recipe works. The inventors recommend the potato/carrot or corn/oat recipe as described herein.

### Example 13

The molecular composition of the disclosed bitter blocker was determined from a sample made from two 40 L batches of a 200 L C. sinensis submerged culture grown in an 8 g/L organic potato starch powder and 0.8 g/L organic carrot powder RO water media. The culture had been harvested at 41 and 48 days for a total of 230 g of powder bitter blocker (a yield of −2.9 g/L), which was mixed together. 150 g of the sample was used for third party compositional analysis. The data, taken in technical duplicate, shows that this batch of bitter blocker is 86.9% carbohydrate. The material is further composed of, in descending rank of concentration: water, ash, fat and protein. No molecules foreign to the food supply were detected in this study. These data are summarized in Table 2, while more detailed information is shown in subsequent tables. Kilocalories (commonly called ‘calories’ on food labels) are listed as well. The bitter blocker is typically processed on the 8^{th}-12^{th} day of culturing, but this approach was taken to develop understanding of the most concentrated form of the product, i.e. the most transformed media.

TABLE 2
Summary of biological components in the bitter blocker*

| | Run 1 | Run 2 | Average |
|---|---|---|---|
| Moisture (Vacuum oven) | 6.0 | 6.0 | 6.0 |
| Protein | 1.0 | 1.0 | 1.0 |
| Fat (acid hydrolysis) | 2.3 | 1.6 | 2.0 |
| Ash | 4.2 | 4.2 | 4.2 |
| Carbohydrates | 86.5 | 87.2 | 86.9 |
| Kilocalories (/100 g) | 371 | 367 | 369 |

*Values reported as percentages of gross powder mass, except for calories as noted.

The lipid content of the bitter blocker is likely responsible for some fraction of its hydrophobic nature. The bitter blocker solubilizes faster when heated to 140-160° F. in aqueous solution. At room temperature the batch took 15 minutes for 0.3 g to solubilize in 500 mL with intermittent agitation. The lipid content, shown in Table 3, is composed of 10 different molecules and interestingly enough contains both essential fatty acids. The molecular structures of these molecules, and all molecules in subsequent tables, are shown in the appendix. The sum of the averages indicates that these data account for 99.3% of the total lipid profile.

TABLE 3
Summary of lipid and fatty acid content in the bitter blocker*

| | Run 1 | Run 2 | Average |
|---|---|---|---|
| Capric acid | ND | 0.86 | N/A |
| Lauric acid | 6.31 | 8.35 | 7.33 |
| Myristic acid | 4.62 | 5.24 | 4.93 |
| Palmitic acid | 15.9 | 16.3 | 16.1 |
| Stearic acid | 3.59 | 4.48 | 4.04 |
| Oleic acid | 42.4 | 43.2 | 42.8 |
| Linoleic acid | 21.1 | 15.1 | 18.1 |
| α-Linolenic acid | 3.95 | 4.48 | 4.04 |
| Arachidonic acid | 0.74 | 0.86 | 0.80 |
| 11-Eicosenoic acid | 0.63 | 0.82 | 0.73 |

*Values are reported as percentages of the total lipid profile, which is shown to be 2% of the total material on average.
*ND means not detectable. The variation in lipid content reveals inhomogeneity of lipid distribution within the sample.

The fat content, shown in Table 4, provides the breakdown of saturated, poly- and monounsaturated fat, and the omega acid breakdown of the sample.

TABLE 4
Summary of fat content in the bitter blocker*

| | Run 1 | Run 2 | Average |
|---|---|---|---|
| Saturated fat | 31.1 | 36.1 | 33.6 |
| Polyunsaturated fat | 25.0 | 19.2 | 22.1 |
| Monounsaturated fat | 43.9 | 44.7 | 44.3 |
| Trans fatty acids | ND | ND | N/A |
| Omega 3 fatty acids | 3.95 | 4.08 | 4.02 |
| Omega 6 fatty acids | 21.1 | 15.1 | 18.1 |
| Omega 9 fatty acids | 42.4 | 43.2 | 42.8 |

*Values reported as percentages of total fat content, which was shown to be 2% of the total material on average.
*ND means not detectable. Variation in fat content is reflected in variation of lipid content.

Table 5, shown below, details the salt, some elemental, small molecule and vitamin breakdown of the bitter blocker.

TABLE 5
Summary of salt, key elements, vitamins and
small molecules in the bitter blocker*

| | Run 1 | Run 2 | Average |
|---|---|---|---|
| Salt | 1.05 | 1.04 | 1.05 |
| Calcium | 6520 | 6690 | 6605 |
| Potassium | 3260 | 3380 | 3320 |
| Sodium | 5050 | 5290 | 5170 |
| Iron | 93.4 | 99.2 | 96.3 |
| Magnesium | 1620 | 1600 | 1610 |
| Zinc | 15.7 | 14.0 | 14.9 |
| Copper | 32.8 | 32.8 | 32.8 |
| Selenium | 0.16 | 0.15 | 0.16 |
| Manganese | 3.43 | 3.57 | 3.50 |
| γ-Tocotrienol | 12.75 | 12.67 | 12.71 |
| Ergosterol | 0.34 | 0.45 | 0.40 |
| D-Mannitol | 79.64 | 79.53 | N/A |
| Ascorbic acid | 286.86 | 294.80 | 290.83 |

*Values reported in ppm, except for salt which is a percentage of the total material, and γ-tocotrienol, ergosterol and ascorbic acid, which are reported in μg/g.
*The variation in these data reveals homogeneity in some material, though not in all.

The sparse amino acid content of the bitter blocker, shown in Table 6, is composed of aspartic acid, glutamic acid, cysteine and lysine.

TABLE 6
Summary of amino acids in the bitter blocker*

| | Run 1 | Run 2 | Average |
|---|---|---|---|
| Aspartic acid | 0.07 | ND | 0.1 |
| Glutamic acid | 0.09 | 0.10 | 0.1 |
| Cystine | 0.01 | ND | N/A |
| Lysine | 0.03 | 0.03 | 0.03 |

*Values reported as percentages of the total material.

Table 7 shows the carbohydrate content and breakdown of the bitter blocker. The β-glucan and chitin are good indicators of total fungal biomass (as is ergosterol and D-mannitol, shown in Table 5). These data account for approximately 99.8% of the carbohydrate profile.

TABLE 7
Summary of saccharide content in the bitter blocker*

| | Run 1 | Run 2 | Average |
|---|---|---|---|
| Carbohydrates | 86.5 | 87.2 | 86.9 |
| Total Polysaccharides | 487.67 | 449.99 | 468.83 |
| Starch | 59.0 | 58.3 | 58.7 |
| Cellulose | 69.28 | 63.19 | 66.24 |
| Chitin | 114.94 | 127.16 | 121.05 |
| β-glucan | 14.3 | 14.7 | 14.5 |
| Glucuronic acid | 108.08 | 108.07** | 108.07 |
| Xylose | 9.31 | 13.87 | 11.59 |
| Arabinose | 109.02 | 82.63 | 95.83 |
| Mannose + Glucose | 1188.00 | 1165.73 | 1176.86 |
| Sucrose | 1200.88 | 1739.11 | 1469.99 |
| Maltose** | 5900 | N/A | 5900 |

*Carbohydrates and starch reported as percentage of total material, total polysaccharides reported as mg dextran/g, cellulose reported as mg/g, all other values reported as μg/g.
**Maltose assay was only run in singular.

Table 8, shown below, outlines the NBST content of the bitter blocker. The data indicate that salvage pathways are activated to produce the requisite NBST material for growth. Notice how the bitter blocker NBST content is a stripped down set of the C. sinensis powder NBST content. The un-retained NBSTs must be intracellular.

TABLE 8
NBST content of Growth Media Powder, Penn State 859 C. sinensis submerged
culture solids and C. sinesis submerged extracellular portion solids*

| | GMP | Uridine | AMP | Inosine | Guanosine | Adenosine | Cordycepin | Cytidine | Cytosine | Uracil | Thymine | Adenine | Guanine |
|---|---|---|---|---|---|---|---|---|---|---|---|---|---|
| Media | — | — | — | — | 2.58 | — | — | — | 9.23 | — | — | — | — |
| Powder | | | | | | | | | | | | | |
| C. sinensis | 2.71 | — | 2.17 | — | 1.19 | — | — | 1.55 | 9.32 | 7.97 | 9.56 | 17.52 | — |
| powder | | | | | | | | | | | | | |
| Bitter | 4.02 | — | 2.79 | — | — | — | — | — | — | 13.92 | 23.59 | 85.32 | — |
| blocker | | | | | | | | | | | | | |

*Units in μg/g.

A GC/MS investigation revealed three volatile biomolecules present in the bitter blocker. These are hexadecanoic acid methyl ester, 9-octadecanoic acid methyl ester and methyl stearate. Their concentrations will be determined once standards are run.

### Example 14

The C. sinensis extracellular portion powder (bitter blocker) is produced by the methods outlined in Example 4 and used with food products on a ppm basis.

TABLE 9
Bitter Blocker Concentration in Various Final
Bitter Blocking Product Applications*

| | Recommended Bitter Blocker |
|---|---|
| | Concentration (ppm) |
| Steviol Glycoside Mixture | 0.40-1.20 |
| Acesulfame - K | 0.3-1 |
| Aspartame | 0.3-1 |
| Chocolate | 35,000-37,000 |
| Tea | 1,066-1,866 |
| Red Ginseng | 180-220 |
| Zeviva Cola | 0.4-2.0 |
| Coffee Grinds | 7,800-73,000 |
| Coffee Brew | 100-500 |
| 100% Cranberry Juice | 50-3,200 |
| Coconut Water | 100-500 |
| Merlot | 600-3,800 |
| Tequila | 6,400-25,600 |
| Potassium Chloride | 40-60 |
| Vodka | 100-300 |
| Quinoa | 20-30 |
| Amaranth | 40-60 |

*Table 9 does not show how the bitter blocker is formulated into some of these products before application.

### Example 15

The C. sinensis extracellular portion powder (bitter blocker, also known as the flavor modulator, also known as ClearTaste) is produced by the methods outlined in Example 4 and used with food products on a ppm basis. An experiment was conducted to test whether or not the flavor modulator at concentrations of 1, 5, 50 and 100 ppm could inhibit the metallic taste of KCl at concentrations of 67, 134 and 201 mM in 20 mL RO water at room temperature (equivalent to 0.5, 1.0 and 1.5% KCl). 1 g of the flavor modulator was dissolved into 0.1 L of RO water in a 100 mL volumetric flask to make a 1% solution three times. Three separate 100 mL volumetric flasks were filled with 0.5, 1.0 and 1.5 g of KCl, and each filled with 0.1 L of the 1% flavor modulator to make 67, 134 and 201 mM KCl solutions with 1% of the flavor modulator. 15 small dixie cups were divided into three groups of 5. Each group successively had 0.1, 0.2 and 0.3 g KCl placed in every cup (for the appropriate %/mM in 20 mL). All cups were filled with 20 mL RO water. One cup in each group was kept as a control. The other cups had 20, 100, 1,000 and 2,000 μL removed one cup in each group by a clean pipette, thereupon having each volume replaced by the same amount of the 1% flavor modulator solution at the appropriate KCl concentration. Each sample was tasted by two tasters. The experiment was recreated and a summary of the results are shown in Table 10. The experiment showed that at appropriate concentrations the flavor modulator can inhibit the metallic taste of KCl, the formulated solution having a purely salty taste with no metallic flavor at all.

TABLE 10
Metallic Taste Modulating Effect of ClearTaste
on Room Temperature Potassium Chloride*

| | ClearTaste (ppm) | | | | |
|---|---|---|---|---|---|
| KCl (mM) | 0 | 1 | 5 | 50 | 100 |
| 67 | M NS | M NS | M NS | NM NS | NM NS |
| 134 | M NS | M NS | M NS | NM S | M S |
| 201 | M S | M S | M S | NM S | M S |

*number of tasters = 2
M = Metallic taste,
NM = No metallic taste,
S = salt taste,
NS = no salt taste

### Example 16

A 6:1 quinoa flour to basic bread flour was made where 25 ppm of the bitter blocker was added as a dry ingredient during kneading. The dough was baked in a Cuisinart CBK-100 series automatic bread-maker on the gluten free setting. A control dough without the bitter blocker was made under the same circumstances. It was concluded in multiple taste tests between 8 different people that the flavor of the treated bread was much less bitter and without the characteristic quinoa aftertaste. A similar experiment was conducted with a 1:1 amaranth flour to whole wheat flour mix where the bitter blocker was added at 50 ppm. The same results were observed by the same tasters.

### Example 17

A C. sinensis culture that had been cultured for 2.5 days at 25° C. in a bioreactor was vacuumed through a 25 μm filter. The filtrate was pasteurized, concentrated and spray dried. The resulting powder was added to a vitamins and mineral nutraceutical mix at 100 ppm. The resulting vitamin/mineral nutraceutical mix was noticeably less bitter and metallic to tasters. The powder derived from the culture filtrate was also used successfully to suppress the bitterness of OTC cough syrups when added up to 1,000 ppm.

### Example 18

The C. sinensis extracellular portion powder (bitter blocker, also known as the flavor modulator, also known as ClearTaste) is produced by the methods outlined in Example 4 and used with food product comprising a protein concentrate or protein isolates on a ppm basis. An experiment was conducted to test the concentration of the flavor modulator required to neutralize the bitter and astringent tastes in various protein concentrates and isolates. See Table 11, showing the optimum level of flavor modulator for providing a neutralized taste to the proteins on an experimental basis.

TABLE 11

| | Product concentration | Optimum level | |
|---|---|---|---|
| Product | in solution (w/v) | of ClearTaste | |
| Pea protein | 4.8% in water | 40 | ppm |
| Pea protein isolate (80%) in | 7% in water | 15 | ppm |
| protein shake | | | |
| Pea protein isolate organic | 7% in water | 20 | ppm |
| (80%) in protein shake | | | |
| Potato protein | 21% in water | 80 | ppm |
| Soy protein | 3% in water | 50 | ppm |
| Rice protein | 7% in water | 48 | ppm |
| Brown rice protein, organic | 7% in water | 10 | ppm |
| Whey isolate | 22% in water | 40 | ppm |
| Plant protein powder blend (soy, | 13% in water | 8 | ppm |
| wheat, pea) | | | |
| Fermented soy powder | 1.7% in water | 1 | ppm |

Modulation of the bitter off-flavors were noted at the concentrations provided in Table 11. Optimum flavor modulation occurs at the lowest concentrations that bitter, chalky, astringent tastes and lingering tastes are significantly reduced compared to control materials. At less than the optimal flavor modulation, the bitter, chalky, astringent off-notes inherent in the proteins were more prominent. At higher amounts of flavor modulator, the flavors became blander and no additional bitterness blocking is noted.

### Example 19

The C. sinensis extracellular portion powder (bitter blocker, also known as the flavor modulator, also known as ClearTaste) produced by the methods outlined in Example 4, is used for hydration water for the texturized protein in an alternative meat burger formulation. See Table 12 for ingredients:

TABLE 12

| | Product concentration | |
|---|---|---|
| Ingredient | in solution (w/v) | |
| Filtered water, 40 ppm ClearTaste | 29.03 | wt % |
| Filtered water, 40 ppm ClearTaste, for | 25.38 | wt % |
| hydration of textured protein | | |
| Texturized fermented pea/rice protein | 14.5 | wt % |
| Oil, coconut | 7.25 | wt % |
| Oil, canola | 7 | wt % |
| Gluten (vital wheat) | 6 | wt % |
| methylcellulose | 2.75 | wt % |
| Fermented pea/rice protein powder | 2.25 | wt % |
| flavorings | 5.35 | wt % |
| Beet powder | 0.5 | wt % |

The texturized protein is hydrated in the ClearTaste® treated water, for hydration, for 10-15 minutes. Make a blend of remaining dry ingredients. Slowly mix the hydrated texturized protein with the dry blend. Add remaining fat, water and oil and mix slowly until a cohesive mass forms and/or the very first strands of gluten are formed. Chill for approximately 1 hour. Form into 4 oz burger patties and freeze. To serve, thaw, and cook in skillet until internal temperature reaches 165 F.

After grilling the patty, the tasters agreed that the patty had reduced bitterness compared to a control patty made without the addition of ClearTaste®.

The description of the various embodiments has been presented for purposes of illustration and description, but is not intended to be exhaustive or limiting of the invention to the form disclosed. The scope of the present invention is limited only by the scope of the following claims. Many modifications and variations will be apparent to those of ordinary skill in the art. The embodiments described and shown in the figures were chosen and described in order to explain the principles of the invention, the practical application, and to enable others of ordinary skill in the art to understand the invention for various embodiments with various modifications as are suited to the particular use contemplated. All references cited herein are incorporated in their entirety by reference.

1. A composition for oral administration, comprising a combination of a food product comprising a protein concentrate or isolate and an extracellular portion from a mycelial aqueous culture comprising a filamentous fungus, wherein the composition has a reduced undesirable flavor from the protein concentrate or isolate in the food product.

2. The composition of claim 1, wherein the extracellular portion is a dried supernatant from the aqueous culture.

3. The composition of claim 1, wherein the filamentous fungus is selected from the group consisting of: Cordyceps sinensis, Cordyceps militaris, Hericium erinaceus, Agaricus blazei, Grifola frondosa, Auricularia auricula, Flammulina velutipes, Trametes versicolor, Morchella spp., Inonotus obliquus, Laricifomes officinalis, Fomes fomentarius, Fomes officinalis, Fomes fomitopsis, Tricholoma matsutake, Boletus edulis, Clitocybe nuda, Clitocybe saeva, Plearotus spp., Tremella fuciformis, Piptoporus betulinus, Polyporus umbellatus, Pholiota nameko, Volvariella volvacea, Hypsizygus marmoreus, Stropharia rugosoannulata, and Laetiporus sulphureus.

4. The composition of claim 3, wherein the filamentous fungus is Cordyceps sinensis.

5. The composition of claim 1, wherein the extracellular portion is obtained by filtration or centrifugation.

6. The composition of claim 1, wherein the extracellular portion of the mycelial aqueous culture is prepared by a method comprising:
culturing a mycelial aqueous culture in a media;
separating the extracellular portion from the mycelial cells; and
collecting extracellular portion of the mycelial aqueous culture.

7. The composition of claim 1, wherein the undesirable flavor comprises bitter tastes, astringent tastes, and beany aromas.

8. The composition of claim 1, wherein the extracellular portion of the mycelial aqueous culture is pasteurized or sterilized.

9. The composition of claim 1, wherein the extracellular portion of the mycelial aqueous culture is collected by filtration or centrifugation.

10. The composition of claim 6, wherein the extracellular portion of the mycelial aqueous culture is centrifuged to separate it from mycelial cells.

11. The composition of claim 6, wherein the culturing step is performed for between one day and sixty days.

12. The composition of claim 1, wherein the food product is a dairy alternative products, beverages and beverage bases, extruded and extruded/puffed products, meat imitations and extenders, baked goods and baking mixes, granola products, bar products, smoothies and juices, and soups and soup bases.

13. The composition of claim 1, wherein the protein concentrate or isolate is derived from pea, potato, soy, rice, brown rice, whey, wheat gluten, wheat, hemp, oat, duckweed, cyanobacteria, grain, chia, chickpea, algae, corn gluten meal, nettle or combinations of these.

14. The composition of claim 15, wherein the concentrate or isolate is from pea.

15. A method to improve the taste of a food composition, comprising combining an extracellular portion of a mycelial aqueous culture comprising a filamentous fungus with a food product comprising a protein concentrate or isolate, wherein the composition has a reduced undesirable flavor from the protein concentrate or isolate in the food product.
